(19) United States
(12) Patent Application Publication
(10) Pub. No.: US 2009/0115890 A1
(43) Pub. Date: May 7, 2009

(54) Protection case for cameras which are capable of transmitting a video signal

(76) Inventor: Giovanni Battista Bertollo Conte, Carre (IT)

Correspondence Address: HEDMAN & COSTIGAN P.C., 1185 AVENUE OF THE AMERICAS, NEW YORK, NY, 10036, US

(21) Appl. No.: 12/220,450

(22) Filed: Jul. 24, 2008

(30) Foreign Application Priority Data
Aug. 2, 2007 (IT) VI2007A 213

(51) Int. Cl. H04N 5/225

(52) U.S. Cl. 348/373; 348/E05.024

(57) ABSTRACT

A protection case (10) for cameras (22), which are capable of transmitting a digital video signal, wherein the case (10) is equipped with fittings that require an appropriate supply voltage for their operation; the case (10) has internally at least one splitter (17), which is connected to the supply mains (15) of the camera (22) and which is directly connected to the camera (22), and the splitter (17) is able to support both the supply mains signal and a supply voltage, so as to connect said fittings to the supply voltage, through at least one electric wire (32) outputting the splitter (17).

The present invention relates to a protection case for cameras of the so-called “network cameras” or “IP cameras” type, which are able to transmit a digital video signal.

Until a few years ago, the video surveillance was performed by means of one or more cameras with an output analog video signal.

The video signal was led, through an adequate coaxial cable, from the take point, where the camera was installed, to the other peripheral units for the vision, the registration and the whole operation of the surveillance plant.

For some years now, the so-called “network cameras” (or “IP cameras”) are also available on the market for video-surveillance systems or closed circuit TV (CCTV), i.e. cameras where no output connections for transmitting an analog video signal are provided, but an Ethernet-type output connection is present.

Therefore, said cameras are able to transmit a digital video signal, through a computer network.

Some last-generation “network cameras” or “IP cameras” also support a particular operation mode, so-called “PoE” or “HiPoE” in a power extended version, according to which, through appropriate equipment placed in the network structure, it is possible to provide the camera with both the supply mains signal and the supply voltage that is required to operate said camera only by means of the mains cable.

Anyway, cameras must necessarily be protected from dust and weather in order to be placed both inside and outside the premises to be monitored and therefore suitable protection cases, equipped with adequate watertight, are used.

Said protection cases are normally equipped with fittings, which allow for correctly operating the camera and for a correct view of the shoot scene.

Said fittings are typically a heating resistor (or a PTC resistor), placed near the taking lens and controlled by a thermostat, which is used for avoiding the fogging of the taking windows, due to moisture or external low temperatures, and/or a cooling fan, which is used for achieving an adequate ventilation at high external or internal temperatures, making it possible to extract the heat generated by the camera and to take it outside the case, allowing the camera to operate in a proper range of operating temperatures.

As you can imagine, said fittings need a suitable supply voltage to work.

However, this need for a power supply source collides with the new technology of the “network cameras” operating according to the PoE or HiPoE mode, which, as we have seen, allows to feed only cameras which are compatible with said system, but does not allow to feed the fittings, thereby making impossible a proper installation of the assembly camera/case in external or internal environments.

Moreover, the system is obviously incompatible with the known “network cameras” or “IP cameras” or with the cameras which are only compatible with the digital network.

It is thus necessary to provide, in addition to the mains connection, an external electrical power source, which consequently involves an increase of work and of overall dimensions and cost-push for providing the installation.

Furthermore, this drawback does not allow the use of all known “network cameras” or “IP cameras” which are not compatible with the above-mentioned system.

It is therefore an object of the present invention to overcome the above-mentioned drawbacks and, in particular, to indicate a protection case for cameras capable of transmitting a digital video signal, which allows for a proper installation of the assembly camera/case, both in external environments and in internal environments, in a simple, quick and economic way.

Another object of the invention is to indicate a protective case for cameras capable of transmitting a digital video signal, which allows for using all known cameras of the so-called “network camera” or “IP camera” type, which are normally not compatible with the so-called PoE or HiPoE operating mode, according to which, through only the mains cable, it is possible to feed the camera both with the mains connection signal and with the supply voltage required to operate said camera itself.

Another object of the invention is to indicate a protection case for cameras capable of transmitting a digital video signal, which is extremely reliable and of simple and inexpensive implementation.

These and other objects, according to the present invention, are achieved by means of a protective case for cameras capable of transmitting a digital video signal, according to the enclosed claim 1. Other detailed technical features can be found in the dependent claims.

Advantageously, suitable separation and/or splitting devices (so-called “splitter”) are provided in the protection case according to the invention, said devices having compatibility with the PoE or HiPoE system or being capable of supporting, through only the mains cable, both the mains connection signal and a supply voltage.

Said devices (“splitter”) are able to provide their outputs with a mains connection which is separate from the supply voltage, allowing to connect a power supply source to the fittings that are essential for the proper functioning both of the camera and of the case (heating resistor, fan, etc.) and allowing also to correctly feed cameras of the so-called “network cameras” or “IP cameras” type, which are not directly compatible with the PoE or HiPoE operating mode.

Consequently, there is no need for the installer to provide separate power sources, with obvious savings in terms of low cost and simplicity of installation; moreover, there is greater safe with respect to the known techniques, because there is no longer need to have mains supply voltages, even dangerous, inside the case and the installer is thus able to access the known so-called “network camera” or “IP camera”, although not compatible with the PoE or HiPoE operation mode; it is thus possible to choose freely the camera with the technical characteristics which are better suited to specific requests from the installer and on the basis of the availability of cameras.

Finally, using the protective case described in the present application, there are many advantages for the installer, both in terms of greater choice of cameras and in terms of easiness and convenience, economy and safeness.

Additional features and advantages of a protective case for cameras capable of transmitting a digital video signal, according to the present invention, will be more evident from the following description, relating to a preferred and not limited embodiment, and from the enclosed drawings, wherein:

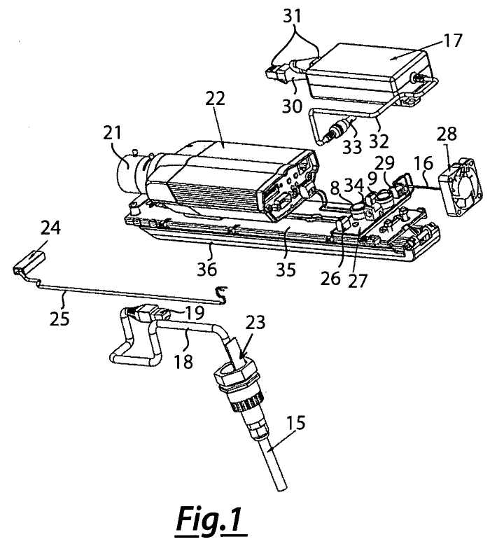

FIG. 1 shows a partial exploded view of a protective case for cameras capable of transmitting a digital video signal, according to the present invention;

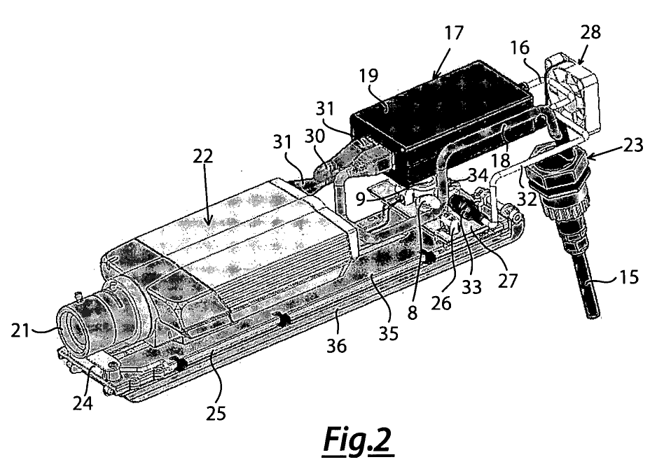

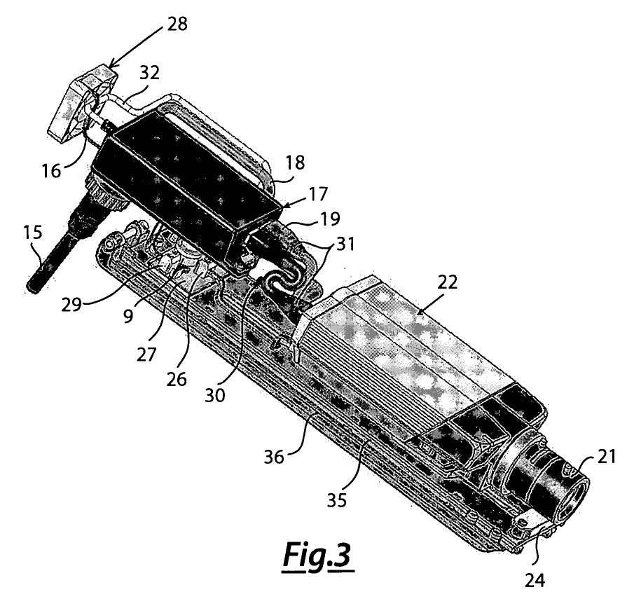

FIGS. 2 and 3 show two perspective views of the protection case shown in FIG. 1, according to this invention, when the electrical connections are made;

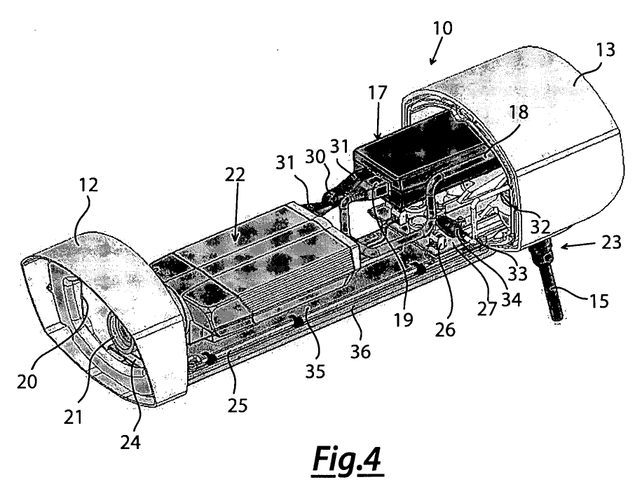

FIG. 4 is a perspective view of a partly assembled protective case for cameras, according to the present invention;

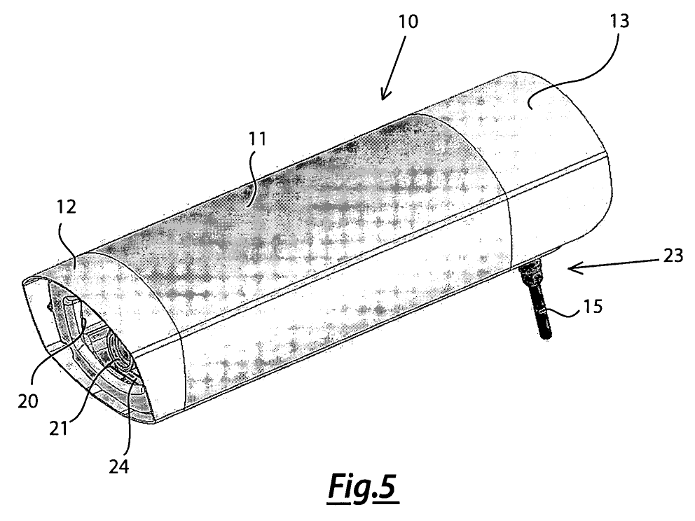

FIG. 5 is a perspective view of an assembled protective case for cameras, according to the present invention.

With reference to the above-mentioned figures, 10 generally indicates a protective case for cameras, according to the present invention, which, according to a preferred, but not limited, embodiment includes a central body 11, which is tubular-shaped and normally made from extruded aluminum, a front terminal portion 12, with a window or another shaped transparent element 20, which is located at a seat positioned at the lens 21 of the camera 22, and a rear terminal portion 13 having electrical connections for connecting the Ethernet cable 15 (FIG. 4-5); according to other embodiments, the protection case 10 may also include at least two bodies, one hinged with the other.

The invention relates particularly to a protective case 10 for video-surveillance cameras, which are so-called “network cameras” or “IP cameras”, or for CCTV cameras, which have outputs with the electrical connections 23 for connecting the Ethernet-type cable 15, in order to transmit a digital video signal through a computer network.

The protection case 10 is normally equipped with technical fittings which are needed for a proper functioning of the camera 22 and for a correct view of the scene.

Said technical fittings can typically include at least one heater element 24 (a heating resistor or PTC), placed near the shooting window 20 and electrically connected, through the cable 25 which is laid on the internal sleigh 35 (associated with the external sleigh 36) of the case 10 and through the clamp 26, with a thermostat 8, which is mounted on the board 27, so as to avoid the steaming up of the shooting window 20 because of humidity or low external temperatures, and/or at least a fan 28, which is connected, through an electrical conductor 16 and a clamp 29, with a thermostat 9 mounted on the board 27, able to extract the heat generated by the camera 22 and to take said heat outside the case 10, in order to enable the camera 22 to operate in a correct range of operating temperature values.

According to the invention, in order to have a power source for said fittings and thus obtain a complete functionality of the camera 22, a splitter 17 is provided which is compatible with the so-called “network cameras” or “IP cameras”; the splitter 17 is able to supply, only through the Ethernet cable 15, both the mains supply signal and a supply voltage (FIG. 1-3).

The splitter 17, which is placed inside the case 10, is thus able to provide its outputs, through the wire 18 and the connector 19, with the mains supply, which is separated from the supply voltage.

The supply voltage, which is also supplied by the conductor 30 and by the connectors 31 allowing connection between the splitter 17 and the camera 22 through the socket 37, may be provided to the fittings (the heating resistor 24 and/or the fan 28), through the conductor 32 and through the connector 33, which can be inserted into the terminal 34 of the board 27.

This also allows to correctly feed cameras 22 of the type so-called “network cameras” or “IP cameras” which are not directly compatible with the operating mode PoE or HiPoE (an operating mode according to which, through only the mains supply cable, it is possible to supply the camera both with the mains supply signal and with the supply voltage required to operate said camera).

Using this type of connection, it will be enough for the installer simply to connect the splitter 17 with the camera 22 and with the Ethernet cable 15, on the one hand, and, on the other hand, with the mains supply clamp 34 of the circuit which is mounted on the board 27.

The installer should not therefore provide separate power sources, with obvious savings in terms of cost and simplicity of the installation and with greater safety, with respect to the prior art, because it is no longer required to have supply voltages, which sometimes are even dangerous, inside the case 10.

The installer can also access the various known types of “network cameras” or “IP cameras”, even if said types of cameras are not compatible with the PoE or HiPoE operation mode, and it is thus possible to choose more freely the model with the technical characteristics which are better suited to the installation specific requests and on the basis of the availability of cameras.

There are therefore high advantages for the installer, in terms of easiness and quickness of installation and possibility of choosing the camera and practicality, economy and safety.

From the above description the features of the protection case capable of transmitting a digital video signal, which is the object of the present invention, are clear, as well as the resulting advantages are also clear.

Finally, it is clear that many variations can be made to the protection case of the invention, while not leaving the principles of novelty inherent to the inventive idea, as well as it is clear that in practical implementation of the invention, materials, shapes and sizes of the described component parts can be modified and replaced with other parts that are technically equivalent.

1. Protection case (10) for digital cameras (22) of the so-called “network cameras” or “IP cameras” type, said cameras (22) being able to transmit a digital video signal through a computer network, particularly for closed circuit video-surveillance plants (CCTV), wherein said case (10) is equipped with fittings acting for a proper operation mode of the camera (22) and for a correct view of the taken scenes, said fittings requiring a suitable supply voltage for their operation, characterized in that at least one signal splitter device (17) is placed inside said case (10), said splitter device (17) being connected with at least one mains supply cable (15) of the camera (22) and being directly connected with said camera (22), said mains supply cable (15) being capable of providing both a mains supply signal and a supply voltage, also providing an output mains supply connection which is separated from the supply voltage and allowing a connection between said supply voltage and said fittings, through at least one conductor (32) outputting from said at least one signal splitter device (17), so as to correctly feed all types of digital cameras (22) of the so-called “network cameras” or “IP cameras” type.

2. Protection case (10) as claimed in claim 1, characterized in that said case (10) comprises at least one tubular-shaped central body (11), at least one front terminal portion (12), which is equipped with at least one shooting window (20), placed in front of a lens (21) of the camera (22), and at least one rear terminal portion (13), which is equipped with connections (23) for connecting said mains supply cable (15).

3. Protection case (10) as claimed in claim 1, characterized in that said case (10) includes at least two bodies that are hinged one with respect to the other.

4. Protection case (10) as claimed in claim 1, characterized in that said fittings include a heating element (24), which is placed near a shooting window (20) and electrically connected to at least one thermostat (8), able to avoid the steaming up of said shooting window (20) which may arise due to moisture or low external temperatures, and/or to at least one fan (28), which extracts the heat generated by the camera (22) leading it outside the case (10), so as to enable the camera (22) to operate in a proper range of operating temperature values.

5. Protection case (10) as claimed in claim 1, characterized in that said signal splitter device (17) is compatible with cameras (22) of the so-called “network cameras” or “IP cameras” type.

6. Protection case (10) as claimed in claim 1, characterized in that said signal splitter device (17) is able to supply, through only said mains supply cable (15) which is connected to said splitter device (17) by means of at least one first connector (19), a mains supply signal which is separated from a supply voltage, said supply voltage being provided by means of at least one second connector (31), which is able to connect said splitter device (17) to said camera (22).

7. Protection case (10) as claimed in claim 1, characterized in that said conductor (32) outputting said splitter device (17) is connected with at least one clamp (34), placed on at least one board (27), to which said fittings of the case (10) are connected.

8. Protection case (10) as claimed in claim 1, characterized in that said signal splitter device (17) is provided for correctly feeding cameras (22) of the so-called “network cameras” or “IP cameras” type, which are not directly compatible with PoE or HiPoE operating modes.
